(19) United States
(12) Patent Application Publication
(10) Pub. No.: US 2022/0058683 A1
(43) Pub. Date: Feb. 24, 2022

(54) Systems and Methods for Monitoring and Reducing Recidivism

(71) Applicant: Crystal D. Deberry, Memphis, TN (US)

(72) Inventor: Crystal D. Deberry, Memphis, TN (US)

(21) Appl. No.: 17/405,998

(22) Filed: Aug. 18, 2021

Related U.S. Application Data
(60) Provisional application No. 63/067,455, filed on Aug. 19, 2020.

(51) Int. Cl. G06Q 30/02; G06Q 50/26

(52) U.S. Cl. CPC G06Q 30/0236; G06Q 50/26

(57) ABSTRACT

Systems, devices, computer program products, and methods for monitoring and reducing recidivism. A system is configured to manage a balance of reward points that reflects an individual's adherence to certain mandates imposed on the individual after the individual is released from a criminal correctional facility. The reward points can be exchanged for goods and services from participating vendors. The individual may receive reward points for complying with a judicial sector mandate, a social program mandate, and the like, and may lose reward points for not complying with these or other mandates or conditions. The system provides valuable approaches for reinforcing societally acceptable behavior by rewarding convicted individuals for good conduct and helping them reintegrate into society after a criminal offense.

### FIELD

The disclosure relates to approaches for monitoring criminal offenders and reducing their recidivism in a criminal justice system. The disclosure provides solutions that encourage societally acceptable behavior, which may be used with existing elements of the criminal justice system that discourage socially unacceptable behavior, to help these individuals have a better chance at changing their behavior and rejoining society. The disclosure provides computer-based systems and related methods for effectively implementing the solutions.

### BACKGROUND

Over 50% of individuals released from prison or other correctional facilities have a mental illness, and 60-75% remain unemployed and unable to afford basic necessities needed to enable these individuals to sustain themselves and have a chance at changing their behavior. These barriers are determinative of recidivism rates for these recently released prisoners. While attempting to rebuild their lives, recently freed individuals find insufficient access to resources, such as social programs, that could be used to help stabilize their lives. In addition to a lack of access to these and other resources, there is also a lack of cohesion between resources and other services, further diminishing the overall effectiveness of these resources and increasing the risk of recidivism.

Accordingly, there is a need for approaches that improve accessibility of resources needed to avoid recidivism, and which also improve the connectivity between these resources to facilitate societal reentry, and in addition, there is a need for approaches that utilize incentives to increase and sustain participation in these resources. The present invention addresses this unmet need.

### SUMMARY

In one aspect, the disclosure provides a system for managing and reducing recidivism in a participant, the system comprising: a processor configured to: receive data that relates to a compliance of the participant with a mandate imposed on the participant by an authority as a result of a previous behavior by the participant; compute an amount of reward points to increase or decrease a balance of reward points associated with the participant based on the compliance; update the balance of reward points based on the computed amount of reward points; receive a request to redeem a reward for the participant that requires at least a threshold of reward points for redemption of the reward; and determine whether the balance of reward points associated with the participant exceeds the threshold.

In another aspect, the disclosure provides a method for managing and reducing recidivism in a participant, the method comprising: receiving information that relates to a compliance of the participant with a mandate imposed on the participant by an authority as a result of a previous behavior by the participant; computing an amount of reward points for increasing or decreasing a balance of reward points associated with the participant based on the compliance; updating the balance of reward points based on the computed amount of reward points; receiving a request to redeem a reward for the participant that requires at least a threshold of reward points for redemption of the reward; and determining whether the balance of reward points associated with the participant exceeds the threshold.

In another aspect, the disclosure provides a computer program product for managing and reducing recidivism in a participant, the computer program product comprising: a non-transitory computer-readable medium storing executable instructions that, when executed by a processor, configure the processor to: receive data that relates to a compliance of the participant with a mandate imposed on the participant by an authority as a result of a previous behavior by the participant; compute an amount of reward points to increase or decrease a balance of reward points associated with the participant based on the compliance; update the balance of reward points based on the computed amount of reward points; receive a request to redeem a reward for the participant that requires at least a threshold of reward points for redemption of the reward; and determine whether the balance of reward points associated with the participant exceeds the threshold.

In various implementations, the systems and/or devices and/or methods may be configured to: provide a notice of a point deficiency to a user of the system if the balance of reward points is less than the threshold, and/or provide information related to redemption of the reward to a user of the system if the balance of reward points is equal to or greater than the threshold. Once the participant receives the information related to redemption of the reward, the participant may redeem the reward in person or remotely (e.g., virtually) depending on the availability and/or the type of reward.

In addition, in various implementations, the systems and/or devices and/or methods may be configured to: provide a notice to a user of the system if the participant has not complied with the mandate, and/or add a supplemental mandate for the participant to complete. In accordance with an embodiment of the present disclosure, supplemental mandates include, but are not necessarily limited to, a judicial sector mandate, a social program mandate, or both.

In view of the foregoing, it will be appreciated that the present disclosure provides improved approaches for monitoring and reducing recidivism. The specific systems and techniques for accomplishing the advantages described above will become apparent from the following detailed description of the embodiments and the appended drawings and claims.

Other objects, features, and advantages of the invention will become apparent from the following detailed description taken in conjunction with the accompanying drawings.

### BRIEF DESCRIPTION OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 shows a depiction of a system in accordance with an embodiment of the present disclosure.

FIG. 2 shows a depiction of a block diagram of method steps and/or computer operations for requesting a reward in accordance with an embodiment of the present disclosure.

FIG. 3 depicts a flowchart of an implementation of method steps and/or computer operations for managing reward requests in accordance with an embodiment of the present disclosure.

FIG. 4A depicts a user interface showing a login prompt for a participant in accordance with an embodiment of the present disclosure.

FIG. 4B depicts a user interface showing a survey for a program in accordance with an embodiment of the present disclosure.

FIG. 4C depicts a user interface showing an event calendar for scheduling events of a social program in accordance with an embodiment of the present disclosure.

FIG. 4D depicts a user interface showing several events related to a social program in accordance with an embodiment of the present disclosure.

FIG. 4E depicts a user interface of a rewards selection queue in accordance with an embodiment of the present disclosure.

### DETAILED DESCRIPTION OF THE INVENTION

Reference is made herein to the attached drawings. Like reference numerals may be used in the drawings to indicate like or similar elements of the description. The figures are intended for representative purposes and should not be considered limiting.

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

Whenever appropriate, terms used in the singular will also include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and are not intended to be limiting. The term “such as” also is not intended to be limiting. For example, the term “including” shall mean “including, but not limited to.”

As used throughout, the singular forms “a,” “an” and “the” include plural referents unless the context clearly dictates otherwise. Thus, for example, reference to “a gasket” may include two or more such gaskets unless the context indicates otherwise.

As used throughout, “substantially” with respect to a measure may refer to a range of values comprising +/−10 degrees. For example, substantially orthogonal, normal, or parallel may include embodiments, where the referenced components are oriented +/−10 degrees of being classified as orthogonal, normal, or parallel respectively.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the need points of each of the ranges are signified both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

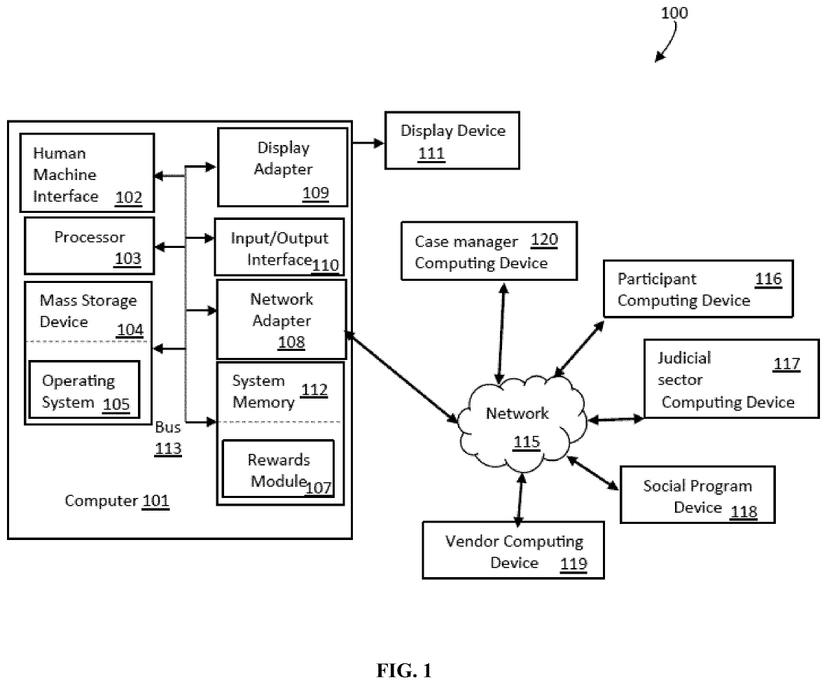

Referring now to FIG. 1, there is depicted a system in accordance with an embodiment of the present disclosure. Certain implementations of the invention involve using a system 100 for carrying out computer operations and/or method steps of the disclosure. The system 100 may be comprised of a plurality of interconnected functionalities which may be embodied as a plurality of suitably configured and networked computing devices (e.g., computer 101, participant computing device 116, judicial sector computing device 117, social program device 118, vendor computing device 119, case manager computing device 120) interconnected with a network 115. Any one or more of these devices may comprise operably connected computer hardware components as needed for the operations and methods. In a particular embodiment, each of computer 101, case manager computing device 120, participant computing device 116, judicial sector computing device 117, social program device 118, and vendor computing device 119 comprises a plurality of suitable computer hardware components for executing a software application. In accordance with an embodiment of the present disclosure, suitable computer hardware components for this purpose may include, but may not necessarily be limited to, components shown for computer 101 which are capable of being included in each of the case manager computing device 120, the participant computing device 116, the judicial sector computing device 117, the social program device 118, and the vendor computing device 119, including a bus 113 which operably connects a display adapter 109 for driving a display device 111, an input/output interface 110, a network adapter 108 configured for wireless and/or wired networking, a system memory 112, a human-machine interface 102, a processor 103, a mass storage device 104 and an operating system 105.

In various implementations, one or more networked computing devices, such as the computer 101 as shown, may comprise a rewards module 107 to configure the processor 103 to perform operations and/or method steps of the disclosure, in whole or in part, in any suitable order. The rewards module, along with any other modules, steps, and/or functionalities disclosed herein, may be in the form of a set or a subset of machine-readable and/or computer-readable instructions stored on a memory, such as system memory 112 (e.g., a non-transitory computer-readable storage medium and/or a non-transitory machine-readable storage medium) which, when executed in whole or in part by the processor 103, cause the processor 103 to perform operations and/or method steps of the disclosure, in whole or in part, in any suitable order.

In at least one aspect in accordance with an embodiment of the present disclosure, methods and computer operations of the disclosure may be implemented on the computer 101 and/or the system 100, for example, as illustrated in FIG. 1 and as described below. The system 100 may utilize one or more computers 101 to perform one or more functions in one or more locations. An operating environment in accordance with an embodiment of the present disclosure utilizes multiple locations for computing devices, but this is only an example of an operating environment and is not intended to suggest any limitation as to the scope of use or functionality of operating environment architecture. Neither should the operating environment be interpreted as having any dependency or requirement relating to any one or any combination of components illustrated in the operating environment in accordance with an embodiment of the present disclosure.

Methods and computer operations may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, and mainframe computers, distributed computing environments that comprise any of the above systems or devices, and the like.

Methods and computer operations of the disclosure may be carried out by software components executable by one or more hardware processors and/or one or more processor circuitries. The disclosed systems and methods may be described in the general context of computer-executable instructions, such as program modules, being executed by one or more computers or other devices. Generally, program modules comprise computer code, routines, programs, objects, components, data structures, etc. that performs particular tasks or implement particular abstract data types. The disclosed methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods disclosed herein may be implemented via a general-purpose computing device in the form of computer 101. Components of computer 101 may comprise, but are not limited to, one or more processors 103, a system memory 112, and a system bus 113 that couples various system components including the one or more processors 103 to the system memory 112. The system may utilize parallel computing.

The system bus 113 represents one or more of several possible types of bus structures, including a memory bus or memory controller, a peripheral bus, an accelerated graphics port, or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The system bus 113, and all buses specified in this description may also be implemented over a wired or wireless network connection and each of the subsystems, including the one or more processors 103, a mass storage device 104, an operating system 105, a network adapter 108, the system memory 112, an Input/output Interface 110, a display adapter 109, a display device 111, and a human machine interface 102, may be contained within one or more remote computing devices 116-120 at physically separate locations, connected through buses of this form, in effect implementing a fully distributed system.

The computer 101 typically comprises a variety of computer readable media. Readable media in accordance with an embodiment of the present disclosure may be any available media that is accessible by the computer 101 and comprises, for example and not meant to be limiting, both volatile and non-volatile media, removable and non-removable media. The system memory 112 comprises computer readable media in the form of volatile memory, such as random-access memory (RAM), and/or non-volatile memory, such as read only memory (ROM). The system memory may also comprise a rewards module 107. The rewards module may configure the processor to calculate and/or determine reward points. Reward points may be a numerical score calculated to the affirmative completion of certain programs. The rewards module 107 may further determine when the participant exceeds a threshold score, allowing the participant to redeem a reward.

In another aspect, the computer 101 may also comprise other removable or non-removable, volatile or non-volatile computer storage media. By way of example, FIG. 1 illustrates the mass storage device 104 which may provide non-volatile storage of computer code, computer readable instructions, data structures, program modules, and other data for the computer 101. For example, and not meant to be limiting, the mass storage device 104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. The data for the events may be stored in the mass storage device 104 in any of one or more databases known in the art. Examples of such databases comprise, DB2®, Microsoft® Access, Microsoft® SQL Server, Oracle®, MySQL, PostgreSQL, and the like. The databases may be centralized or distributed across multiple systems. Optionally, any number of program modules may be stored on the mass storage device 104, including by way of example, the operating system 105 and/or an Optical Character Recognition (OCR) module.

In another aspect, the user may enter commands and information into the computer 101 via an input device (not shown). Examples of such input devices comprise, but are not limited to, a keyboard, pointing device (e.g., a “mouse”), a microphone, a joystick, a smayner, tactile input devices such as gloves, and other body coverings, and the like. These and other input devices may be connected to the one or more processors 103 via the human machine interface 102 that is coupled to the system bus 113, but may be connected by other interface and bus structures, such as a parallel port, game port, an IEEE 1394 Port (also known as a Firewire port), a serial port, or a universal serial bus (USB).

In yet another aspect, the display device 111 may also be connected to the system bus 113 via an interface, such as the display adapter 109. It is contemplated that the computer 101 may have more than one display adapter 109 and the computer 101 may have more than one display device 111. For example, a display device may be a monitor, an LCD (Liquid Crystal Display), or a projector. Through the display the device, the user may view a dashboard, user interface portal. In addition to the display device 111, other output peripheral devices may comprise components such as speakers (not shown) and a printer (not shown) which may be connected to the computer 101 via the Input/Output Interface 110. Any step and/or result of the methods may be output in any form to an output device. Such output may be any form of visual representation, including, but not limited to, textual, graphical, animation, audio, tactile, and the like. The display device 111 and computer 101 may be part of one device, or separate devices.

The computer 101 may operate in a networked environment using logical connections to one or more remote computing devices 116, 117, 118, 119, and 120. By way of example, a remote computing device may be a personal computer, portable computer, smartphone, a server, a router, a network computer, a peer device, or other common network node, and so on. Logical connections between the computer 101 and remote computing devices 116, 117, 118, 119, and 120 may be made via a network 115, which may comprise a local area network (LAN) and/or a general wide area network (WAN), or the connection may be made to an external computer (for example, through the Internet using an Internet Service Provider). Transmission of program code embodied on a computer readable medium may occur using any appropriate medium including, but not limited to, wireless, wired, optical fiber cable, radio frequency (RF), or any suitable combination thereof. The network adapter 108 may be implemented in both wired and wireless environments. Such networking environments are conventional and commonplace in dwellings, offices, enterprise-wide computer networks, intranets, and the Internet.

In accordance with an embodiment of the present disclosure, the first remote computing device 116 may be associated with the computing device associated with a participant. The participant may be a person recently released from a prison. The participant may use their computing device 116 as a portal and means of communicating with other components of the system 100. A second remote computing device may be a case manager computing device. The case manager may be an administrator associated with the participant, judicial sector, or social program. The case manager may use the case manager computing device 120 to send and receive data.

Another remote computing device 117 may comprise a judicial sector computing device. The judicial sector computing device 117 may be associated with the state and/or federal judicial sectors. The participants may have been committed crimes against a particular state or federal government. When these participants have completed the terms of their sentences, they may re-enter society under probation. The specific rules and mandates of their probation will be mandated by the respective state or federal government. The judicial sector computing device 117 may include the records of a respective participant's cooperation with probation mandates associated with their release. The information stored on the judicial sector computing devices 117 may be communicated to the computer 101 through the network 115.

In a further aspect, judicial sector computing device 117 may comprise a plurality or network of judicial sector computing devices that communicate with each other. For example, the judicial computing device network may comprise state and federal agencies, wherein the participant may have been sentenced. For example, a first judicial sector computing device 117 may store and/or process data related to Department of Corrections data in Georgia. A second judicial sector computing device 117 may store and/or process data related to the Federal Department of Corrections as associated with the participant.

Another remote computing device 118 may comprise a social program computing device 118. In one aspect, the social program computing device 118 may provide data, such as surveys, to the computer 101. The social program data received by the computer 101 from the social program computing device 118 may be compared to data inputs or survey data provided by the participant computing device 116 to the computer 101. The social program computing device 118 may be configured to communicate with the case manager computing device 120 via the network 115. Similar to the judicial sector computing device 117, the social program computing device 118 may comprise a network or plurality of social program computing devices. Each social program computing device may be affiliated with a different social program such as drunk driving, family counseling, or rehabilitation services.

In a further aspect, the system 100 may comprise a vendor computing device 119. Vendor computing device 119 may be configured to be in communication with various external vendors. Similar to the judicial sector computing device 117, the vendor computing device 119 may comprise a network of vendors. For example, the rewards servicing may be enhanced with offerings associated with each vendor. Rewards may include categories such as grooming services, a food voucher, and/or transportation services. Other vendor services such as entertainment incentives may be included. Within each of the categories, there may be additional vendors that may be preferable to the participant. For example, the vendors under the food category may include different types of cuisine, which would allow the participant more choices and/or control in determining their reward. Similarly, the grooming services and transportations may vary in the vendors that are organized in that respective category. Further, the vendor computing device 119 may be configured to communicate with each of the vendors reward programs. In a further aspect, the vendor computing device 119 may be configured to identify customer reward programs associated with a particular vendor. For example, a barber classified under the grooming services category may provide a reward (e.g., a free haircut).

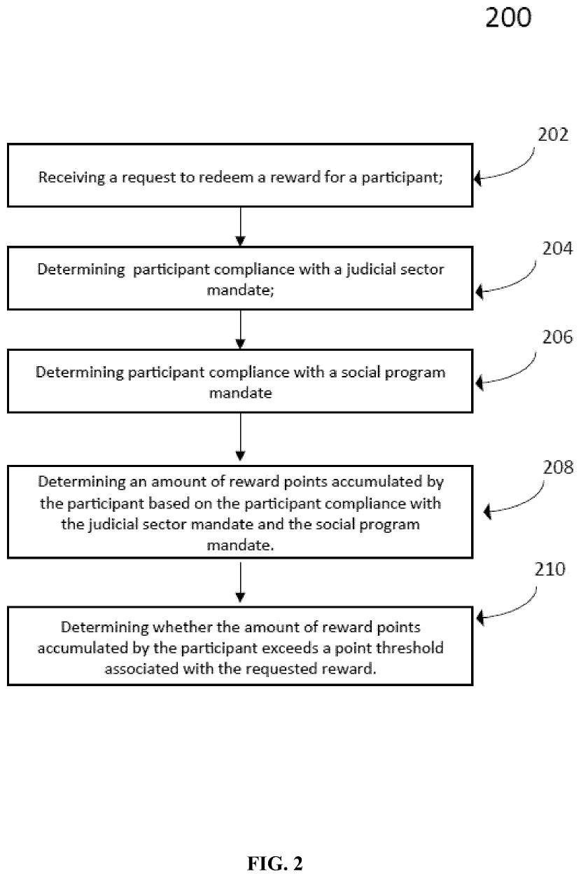

Referring now to FIG. 2, there is depicted a block diagram of method steps and/or computer operations for requesting a reward in accordance with an embodiment of the present disclosure. A method 200 may comprise receiving 202 a request to redeem a reward for a participant. The request may be sent by any individual or entity, including but not necessarily limited to the participant, and the request may be received by any system and/or device, or component thereof, as disclosed herein or equivalents thereof, or may be received by a person. The method 200 may comprise determining 204 whether a participant is following a judicial sector mandate, for example, by receiving reporting data from the participant computing device and determining whether the received reporting data is consistent with terms of the judicial sector mandate. The method 200 may comprise determining 206 participant compliance with a social program mandate for example, by receiving reporting data from the participant computing device and determining whether the received reporting data is consistent with terms of the social program mandate. The method 200 may comprise determining 208 an amount of reward points accumulated by the participant based on the participant's compliance with the judicial sector mandate and the social program mandate, for example, the amount of reward points accumulated by the participant may increase as a result of receipt of information indicating that the participant is complying with a mandate, and/or the amount of reward points accumulated by the participant may decrease as a result of receipt of information indicating that the participant is not complying with a mandate. The received information may be used as the basis for increasing and/or decreasing the amount of reward points accumulated by the participant. The information used for managing reward points may be provided by the participant, a party of the judicial sector, and/or a party of the social program. The method may comprise determining 210 whether the amount of reward points accumulated by the participant exceeds a point threshold associated with the requested reward. If the accumulated reward points exceed the point threshold, then the reward may be accessible and/or provided to the participant; if the accumulated reward points do not exceed the point threshold, then the reward may not be accessible and/or provided to the participant. Because the participant needs the reward and the resulting access to goods and services, the participant is incentivized to follow the mandates and is better equipped to avoid recidivism.

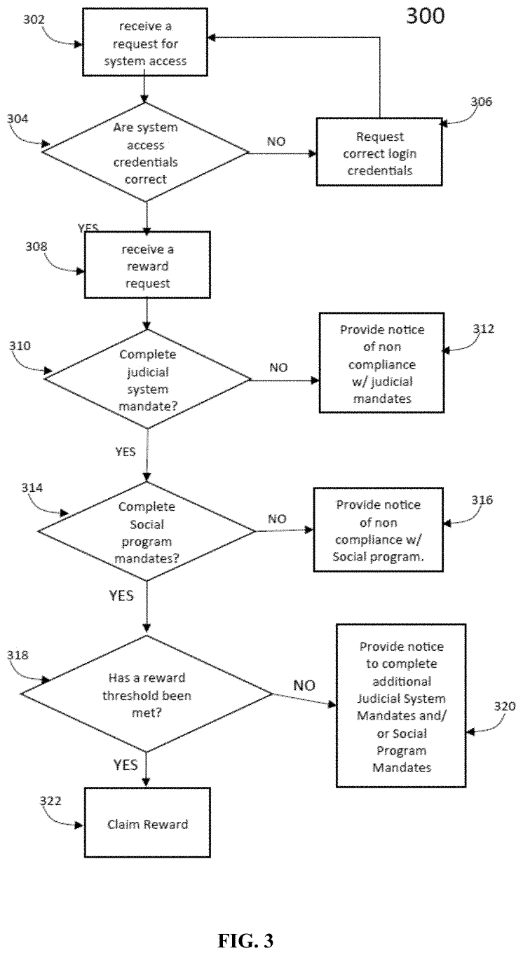

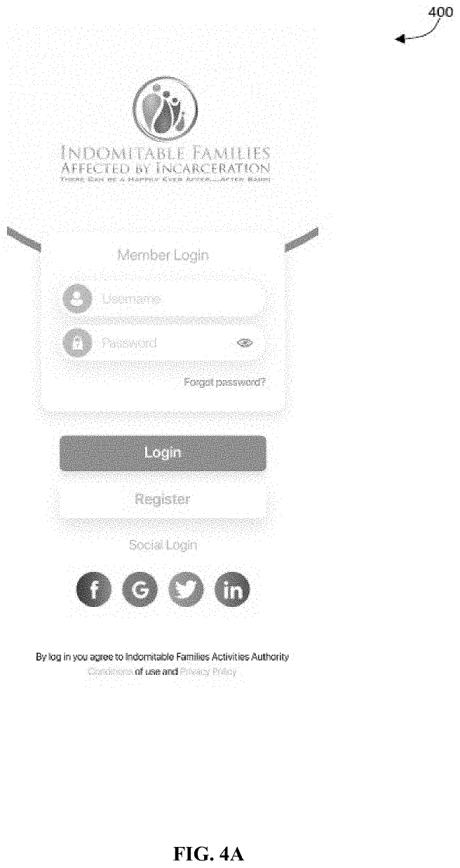

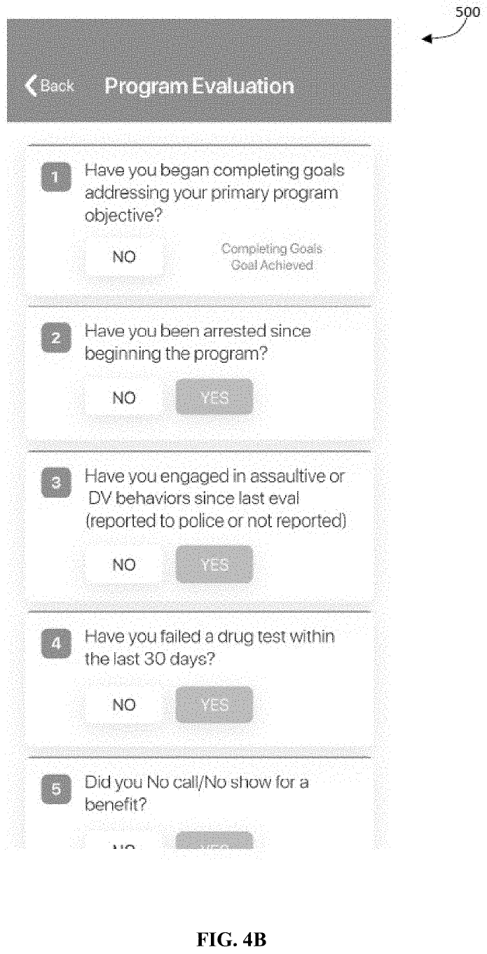

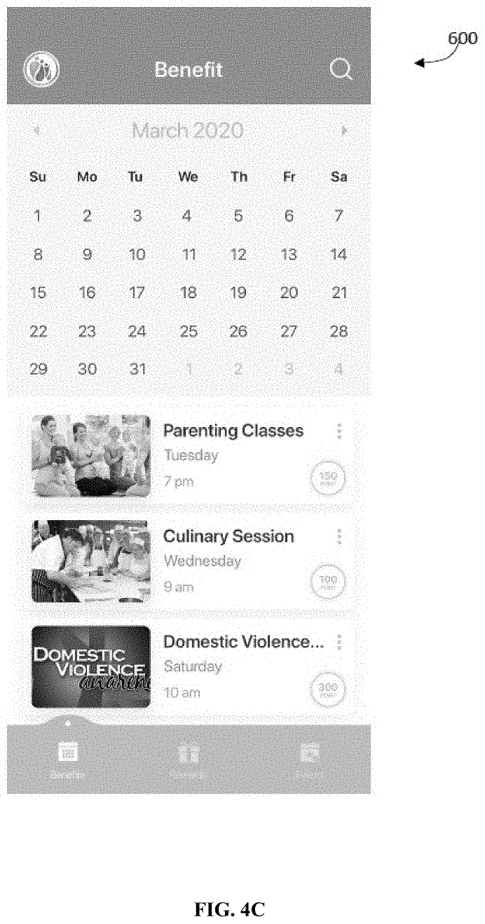

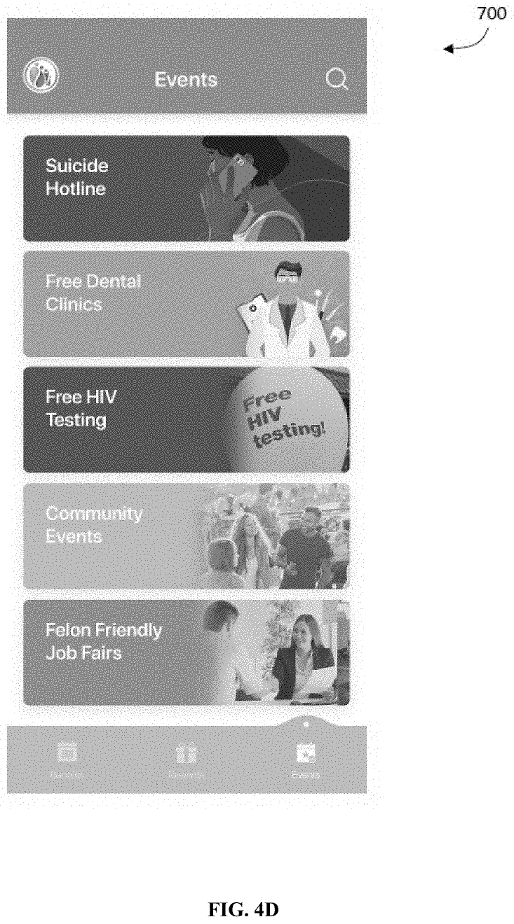

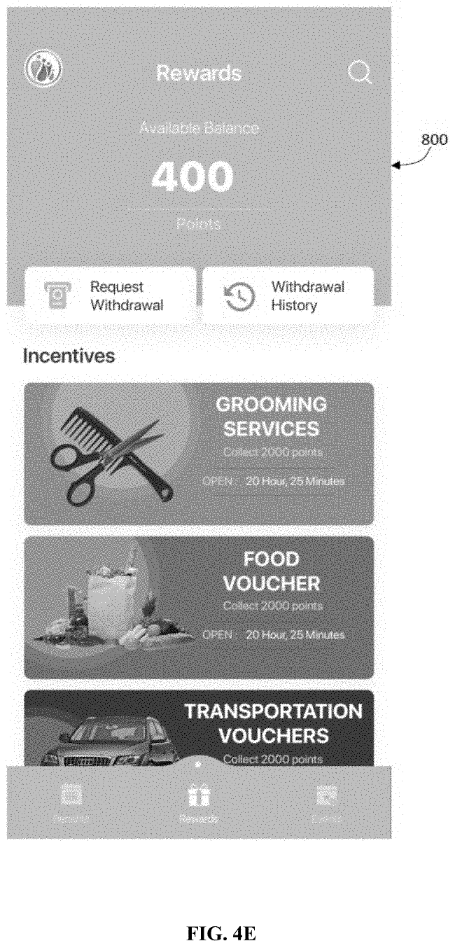

Referring now to FIG. 3, there is depicted a flowchart of an implementation of method steps and/or computer operations for managing reward requests in accordance with an embodiment of the present disclosure. The method steps and/or computer operations are shown and described from the perspective of a system and/or computer (see FIG. 1), in accordance with an embodiment of the present disclosure, having at least one processor configured for performing all or part of the method steps and/or computer operations, in any suitable order, in parallel and/or in series. A processor for performing a method 200 for handling a reward request may be configured to receive 302 a request for access to the system and determine 304 whether system access credentials are correct, and if the credentials are correct (STEP 304: YES), receive 308 a reward request from a user (e.g., a participant accessing the system via a dashboard and/or user interface of the system as displayed on a participant computing device, e.g., 400 of FIG. 4A, which allows the participant to enter a username and password associated with the participant's user profile) of the system, and if the credentials are not correct (STEP 304: NO), request 306 correct login credentials and return to step 302. The processor may be configured to provide notice to and/or lock out the user if a number of failed login attempts exceeds a threshold, which may be an overall threshold or may be based on the number of failed login attempts that occur over a period. The notice may indicate, for example, that the user is locked out and/or the number of login attempts available before the user is locked out of the system.

The received reward request may relate to a particular reward desired by the user and/or the participant. The processor may be configured such that once the reward request is received 308, the processor may determine 310 whether the participant has completed a necessary portion (e.g., a part or an entirety) of a judicial system mandate. If the participant has completed the necessary portion (STEP 310: YES), then the processor may be configured to determine 314 whether the participant has completed a necessary portion (e.g., a part or an entirety) of a social program mandate. If the participant has completed the necessary portion (STEP 314: YES), then the processor may be configured to determine 318 whether the amount of reward points accumulated by the participant exceeds a point threshold associated with the requested reward. If the processor determines that the amount of reward points exceeds the point threshold (STEP 322: YES), then the processor and/or the computer and/or the system, or an individual or group or entity associated with the processor and/or the computer and/or the system, may be configured such that the reward may be accessible and/or provided to the participant and the participant can claim 322 the reward. In certain instances, the processor and/or the computer and/or the system may be configured to provide the requested reward and make the appropriate reduction from the acquired rewards points. If the reward is financial assistance, for example, payment for utilities or rent, the processor and/or the computer and/or the system may be configured to send a notice to the case manager via the case manager computing device. The case manager may collect financial information contained in the notice for submission of the payment on behalf of the participant. In certain implementations, the processor and/or the computer and/or the system may be configured to generate a voucher that is directly redeemable with the vendor and to send the voucher to the participant computing device for access and use by the participant. In the event of a financial reward, such as financial assistance, the participant may enter financial account information into the participant computing device for transmission to the processor and/or the computer and/or the system. Subsequently, the processor and/or the computer and/or the system may send the funds to the appropriate party on behalf of the participant. In addition, the processor and/or the computer and/or the system may be configured to prevent the transfer of reward points between two or more participants.

In certain implementations, the participant can only claim 322 the reward in exchange for a deduction to the amount of their reward points, and in this manner, there is a motivation to maintain a balance of reward points by completing necessary activities such as complying with judicial mandates and social program mandates, as well as avoiding committing a crime and/or being arrested or convicted of the crime.

In implementations, the processor may be configured such that if any queries related to step 320, step 314, and/or step 318 return a negative result (i.e., STEP 320: NO, STEP 314: NO, and/or STEP 318: NO), then the processor may be configured to provide one or more corresponding notices to the user and/or the participant and the participant will not be able to claim 322 the reward. For example, if the participant has not completed the necessary portion of the judicial system mandate (STEP 310: NO), then the system may provide 312 the user and/or participant with a notice of non-compliance with the judicial mandate. The notice may include information regarding insufficiently completed records and/or non-compliance. In a further aspect, the insufficiently completed records may indicate a deficiency and any additional requirements needed to complete the judicial sector mandate. In a further aspect, the computer may determine based on the survey or other received data whether there was inappropriate behavior by the participant. In the case of inappropriate behavior, rewards points may be deducted from the participant's accumulated points. The processor may be configured to end the process 300 due to an identified deficiency.

Similarly, if the participant has not completed the necessary portion of the social program and/or has not completed a social program, or has been non-compliant with the terms of the program (STEP 314: NO), then the system may provide 316 the user and/or the participant with a notice of non-compliance with the social program. The participant may self-report participation and completion of a social program, and/or a portion thereof, by providing survey input, e.g., as shown in FIG. 4B, to the system via the participant computing device. As shown in FIG. 4C, the processor may be configured to provide an additional graphical interface 600 that allows the participant to select from a variety of social programs. The graphical user interface (GUI) may have a calendar function that allows the participant to synchronize their schedule to attend the social programs. As shown in FIG. 4D, the processor may be configured to transmit an interface 700 of addition social program options to the participant computing device. The participant may navigate the interface 700 using the participant computing device. With the participant computing device, the participant may also make selections which may be recorded and/or stored in a memory of a device and/or a computer of the system. In a further aspect, similar to determining compliance with the judicial sector, the case manager may provide data to the computer regarding compliance and/or noncompliance with mandates of a social program via the case manager computing device. In implementations, a determination of non-compliance may cause the system to add supplemental social program classes or mandates to the participant's requirements.

In implementations, if the participant has completed the necessary portion of the judicial system mandate (STEP 310: YES) and also has completed the necessary portion of the social program mandate (STEP 314: YES), but the participant does not have enough reward points in their balance (STEP 318: NO), then the processor and/or the system may provide 320 the user and/or participant with a notice to complete additional judicial system mandates and/or social program mandates. Certain situations may result in such an outcome, for example, if the participant has already spent a sum of their reward points (e.g., on a different reward) that would otherwise have been enough for the participant to claim 322 the reward, then the available balance of reward points would be less than a threshold required to claim 322 the reward. In such a situation, the participant may complete additional judicial system mandates and/or social program mandates to increase their balance of reward points as needed so that they can claim 322 the reward thereafter.

In certain implementations, in determining whether the participant has completed 310 the necessary portion of the judicial system mandate, the processor and/or the system, or a human user or administrator of the system, may weigh input from one or more parties of a state and/or federal judicial sector that provided protocols or procedures that the participant must complete after being released from a state and/or federal correctional facility. Similarly, the processor and/or system may be configured to determine whether the judicial sector mandates are sufficiently completed by receiving and evaluating reporting data provided by the participant and/or the participant computing device. Judicial sector mandates may comprise program rules that a participant must comply with (e.g., passing a drug screening, meeting with a probation officer, and/or complying with any other terms as required upon their release from the correctional facility).

As a non-limiting example shown in FIG. 4B, the participant may self-report their compliance with mandates and programs by entering information directly to a survey 500 associated with, for example, a judicial sector. The processor and/or the system may be configured to tabulate the participant's responses and determine whether the participant has fulfilled the mandates of the judicial sector. Similarly, the processor and/or system may receive and analyze data provided by a case manager and/or a case manager computing device 120. The case manager may provide additional information related to the participant's compliance or non-compliance with a judicial sector mandate and/or a social program.

While the exact arrangement of roles and responsibilities of individuals making, managing, and/or using the systems, devices, methods, and/or operations of the disclosure may vary, in certain implementations, the case manager may be a party (e.g., an individual, a group of individuals, a legal entity, and/or a group of legal entities) that is affiliated with (e.g., an employee of, a contractor for, a consultant for, etc.) an organization (e.g., an agency) that makes, manages, and/or uses the systems, devices, methods, and/or operations of the disclosure. In this manner, the case manager may be privy to information considered relevant in evaluating the participant's progress.

Referring back to FIG. 1, in certain implementations, the processor 103 and/or the system 100 and/or the computer 101 may be configured to determine whether the judicial sector mandates are complete by sending and receiving communications (e.g., over the network 115) to and from the judicial sector computing device 117. As a non-limiting example, the computer 101 may send and receive data to and from a judicial sector computing device 117 that is associated with the Department of Corrections at the Federal level and/or one or more state levels. The processor 103 and/or the system 100 and/or the computer 101 may be configured to determine whether the participant has fulfilled mandates based on information received form the judicial sector computing device 117.

In various implementations, sensitive data in transit over the network 115 and/or data stationary on a memory (e.g., data stored on the mass storage device 104), including, for example, data involving participant identification and/or compliance or non-compliance with the mandates, may be protected from viewing by a third party by implementing a security protocol (for example, a security protocol used by and between the computer 101 and the judicial sector computing device 117 and/or a security protocol used by and between the social program computing device 118) which may implement appropriate device identification and/or data encryption procedures, as known in the art.

Referring now to FIGS. 4A, 4B, 4C, 4D, and 4E, there are depicted several user interfaces of the system, in accordance with an embodiment of the present disclosure, including user interfaces for a login prompt (FIG. 4A), a survey for a program (FIG. 4B), an event calendar for scheduling events of a social program (FIG. 4C), a user interface, in accordance with an embodiment of the present disclosure, showing several events related to a social program (FIG. 4D), and a user interface, in accordance with an embodiment of the present disclosure, of a rewards selection queue (FIG. 4E). While a vertical layout for the user interface is depicted, as may be used with a mobile device, other layouts, such as a landscape layout or another layout, are contemplated without departing from the scope of the disclosure.

In various implementations, reward points may be represented as a numerical score calculated from the beginning of to the completion of, and/or compliance with, certain programs. The rewards module may configure the processor to determine when the participant exceeds a threshold score required to redeem a reward. For example, the judicial sector associated with the federal Department of Corrections or a state Department of Corrections may require certain mandates be completed by the participant upon their release of a correctional facility. For example, re-entrance mandates such as probation meeting attendance or half-way housing rules may serve as the basis of compliance with a program. The rewards score may be further determined by participation in the judicial section and social programs using self-reporting by the participant and/or input from the case manager. The compliance with the activities between the social programs and judicial programs may be maintained and stored in the rewards module. In addition, participants may earn points for attending mental health appointments, life skill sessions, meeting probation and/or parole requirements, alcohol counseling, drug counseling, etc. Each session completed may be worth a pre-determined amount of points, and the rewards (e.g., vouchers) may be pre-purchased from vendors and/or donated from vendors for consumption by successful participants.

In various implementations, participants may be able to pick up the reward items (e.g., goods, services, etc.) and/or vouchers from an office or other physical location managed by an organization, such as an agency, that is responsible for administering the system and services disclosed herein. In addition, certain courses (e.g., Life Skill courses) may be conducted at the office, another physical establishment associated with the agency, and/or virtually (e.g., utilizing an external HIPAA compliant video conferencing platform).

Exact implementations of the systems and devices of the disclosure may vary according to need and availability of components. For purposes of a non-limiting illustration, software application programs and other executable program components, such as the operating system, are illustrated herein as discrete blocks, although it is recognized that such programs and components reside at various times in different storage components of the computer and are executed by one or more processors of the computer and/or system. Any of the disclosed methods and/or operations may be performed, in whole or in part, by computer readable instructions embodied on computer readable media. Computer readable media may comprise any suitable media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. In accordance with an embodiment of the present disclosure, computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information, and which may be accessed by a computer and used to configure one or more processors for the methods and/or operations of the disclosure.

The disclosure is described herein with reference to block and flow diagrams of systems, methods, apparatus, and/or computer program products according to example embodiments of the disclosure. It will be understood that one or more blocks of the block diagrams and flow diagrams and combinations of blocks in the block diagrams and flow diagrams, respectively, may be implemented by computer-executable program instructions. Likewise, some blocks of the block diagrams and flow diagrams may not necessarily need to be performed in the order presented and/or may not necessarily need to be performed at all, according to some embodiments of the disclosure.

Computer-executable program instructions may be loaded onto a general-purpose computer, a special purpose computer, a processor, or other programmable data processing apparatus to produce a particular machine, such that the instructions that execute on the computer, processor or other programmable data processing apparatus create means for implementing one or more functions and/or steps specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special purpose, hardware-based computer systems that perform the specified functions, elements or steps, or combinations of special purpose hardware and computer instructions.

The preceding description is provided as an enabling teaching of the disclosed articles, systems, and methods in their best, currently known embodiments. To this end, those skilled in the relevant art will recognize and appreciate that many changes may be made to the various aspects of the articles, systems, and methods described herein, while still obtaining the beneficial results of the disclosure. It will also be apparent that some of the desired benefits of the present disclosure may be obtained by selecting some of the features of the present disclosure without utilizing other features. Accordingly, those who work in the art will recognize that many modifications and adaptations to the present disclosure are possible and may even be desirable in certain circumstances and are a part of the present disclosure. Thus, the preceding description is provided as illustrative of the principles of the present disclosure and not in limitation thereof.

While the disclosure has been described in connection with what is presently considered to be the most practical and various embodiments, it is to be understood that the disclosure is not to be limited to the disclosed embodiments, but on the contrary, is intended to cover various modifications and equivalent arrangements comprised within the spirit and scope of the appended claims.

The following is claimed:

1. A system for managing and reducing recidivism in a participant, the system comprising:
a processor configured to:
receive data that relates to a compliance of the participant with a mandate imposed on the participant by an authority as a result of a previous behavior by the participant;
compute an amount of reward points to increase or decrease a balance of reward points associated with the participant based on the compliance;
update the balance of reward points based on the computed amount of reward points;
receive a request to redeem a reward for the participant that requires at least a threshold of reward points for redemption of the reward; and
determine whether the balance of reward points associated with the participant exceeds the threshold.

2. The system of claim 1, wherein the processor is further configured to provide a notice of a point deficiency to a user of the system if the balance of reward points is less than the threshold.

3. The system of claim 1, wherein the processor is further configured to provide information related to redemption of the reward to a user of the system if the balance of reward points is equal to or greater than the threshold.

4. The system of claim 1, wherein the processor is further configured to provide a notice to a user of the system if the participant has not complied with the mandate.

5. The system of claim 4, wherein the processor is further configured to add a supplemental mandate for the participant to complete.

6. The system of claim 5, wherein the supplemental mandate comprises a judicial sector mandate, a social program mandate, or both.

7. The system of claim 1, further comprising a non-transitory computer-readable medium storing executable instructions configured to configure the processor when executed.

8. The system of claim 1, wherein the reward is redeemable at a physical location for receipt by the participant of a good, a service, or both, provided by a vendor.

9. A method for managing and reducing recidivism in a participant, the method comprising:
receiving information that relates to a compliance of the participant with a mandate imposed on the participant by an authority as a result of a previous behavior by the participant;
computing an amount of reward points for increasing or decreasing a balance of reward points associated with the participant based on the compliance;
updating the balance of reward points based on the computed amount of reward points;
receiving a request to redeem a reward for the participant that requires at least a threshold of reward points for redemption of the reward; and
determining whether the balance of reward points associated with the participant exceeds the threshold.

10. The method of claim 9, wherein the method further comprises providing a notice of a point deficiency to an individual if the balance of reward points is less than the threshold.

11. The method of claim 9, wherein the method further comprises providing information related to redeeming the reward to an individual if the balance of reward points is equal to or greater than the threshold.

12. The method of claim 9, wherein the method further comprises providing a notice to an individual if the participant has not complied with the mandate.

13. The method of claim 12, wherein the method further comprises adding a supplemental mandate for the participant to complete.

14. The method of claim 13, wherein the supplemental mandate comprises a judicial sector mandate, a social program mandate, or both.

15. The method of claim 9, wherein the updating the balance of reward points comprises increasing the balance of reward points based on the computed amount of reward points.

16. The method of claim 9, wherein the updating the balance of reward points comprises decreasing the balance of reward points based on the computed amount of reward points.

17. The method of claim 9, wherein the reward is redeemable at a physical location for receipt by the participant of a good, a service, or both, provided by a vendor.

18. A computer program product for managing and reducing recidivism in a participant, the computer program product comprising:
a non-transitory computer-readable medium storing executable instructions that, when executed by a processor, configure the processor to:
receive data that relates to a compliance of the participant with a mandate imposed on the participant by an authority as a result of a previous behavior by the participant;
compute an amount of reward points to increase or decrease a balance of reward points associated with the participant based on the compliance;
update the balance of reward points based on the computed amount of reward points;
receive a request to redeem a reward for the participant that requires at least a threshold of reward points for redemption of the reward; and
determine whether the balance of reward points associated with the participant exceeds the threshold.

19. The computer program product of claim 18, wherein the mandate comprises a judicial sector mandate, a social program mandate, or both.

20. The computer program product of claim 18, wherein the reward is redeemable at a physical location for receipt by the participant of a good, a service, or both, provided by a vendor.
